(19) United States
(12) Patent Application Publication
(10) Pub. No.: US 2022/0317341 A1
(43) Pub. Date: Oct. 6, 2022

(54) SPLIT GRADIENT INDEX LENS

(71) Applicant: Peak Nano Optics LLC, Valley View, OH (US)

(72) Inventors: Guy Beadie, Falls Church, VA (US); Richard Lepkowicz, Great Falls, VA (US)

(21) Appl. No.: 17/704,736

(22) Filed: Mar. 25, 2022

Related U.S. Application Data
(60) Provisional application No. 63/169,530, filed on Apr. 1, 2021.

(51) Int. Cl. G02B 3/00; B29D 11/00

(52) U.S. Cl. CPC G02B 3/0087; B29D 11/00355; B29D 11/0073

(57) ABSTRACT

The systems, devices, and methods described herein relate to split GRIN lenses which may compartmentalize a single optical element into various zones of stacked film layers with geometrically coupled interfaces. The optical zones may include independent index of refraction values but may be connected through a nested GRIN contour geometry to allow for fabrication of all zones simultaneously.

### PRIORITY DATA

This application claims priority to U.S. Provisional Patent Application No. 63/169,530, filed Apr. 1, 2020, the entirety of which is hereby incorporated by reference.

### TECHNICAL FIELD

The present disclosure is directed to a systems, devices, and methods to provide optical devices for light manipulation. More specifically, the present disclosure is directed to split gradient index (GRIN) lenses.

### BACKGROUND OF THE DISCLOSURE

Demand for improved image quality requires increasingly complex optical systems. A recognized approach to achieving more complex systems without simply adding lens elements is to incorporate gradient index (GRIN) lenses. A GRIN lens is an inhomogenous optical element in which the index of refraction varies over one or more dimensions of the lens.

Historically, GRIN design and processing methods have been based on a continuously varying index of refraction profile throughout the volume of the optical element. In such a volume, optical rays traverse curved paths rather than straight lines. Over long enough pathlengths these gradual curves can amount to significant ray bending, referred to as optical power, which is normally achieved via instantaneous refraction at a curved glass-air interface. More frequently, these curved paths are used over shorter pathlengths to smoothly and subtly alter ray directions to correct for optical aberrations induced elsewhere in the optical train. However, existing GRIN design and processing methods require several optical elements to achieve different performance objectives, such as increased optical power and aberration control of curved ray paths. The implementations of the present disclosure provide a single optical element that combines optical power with the aberration control of curved ray paths, all within the volume of a single element. In particular, the present disclosure leverages volumes of continuously varying gradient index material that also include step-changes in the refractive index in way that that can be modeled and fabricated for use.

In view of all of the above and the figures, one of ordinary skill in the art will readily recognize that the present disclosure introduces a gradient index (GRIN) device, including a lens volume having a plurality of geometrically coupled interfaces; a first zone including a first contiguous subset of the plurality of geometrically coupled interfaces; and a second zone including a second contiguous subset of the plurality of geometrically coupled interfaces, immediately adjacent to the first zone such that the first zone and the second zone meet at a zone interface, wherein an index of refraction within the first zone varies smoothly across the first contiguous subset, wherein an index of refraction within the second zone varies smoothly across the second contiguous subset, wherein an index of refraction or its spatial gradient at the zone interface exhibits a step change, and wherein optical surfaces bounding the GRIN device have shapes independent of the interface topology of the GRIN device such that the optical surfaces bound the lens volume into a lens shape optimized for an optical design.

In some implementations, an entire volume of the first zone has a homogenous index of refraction. The entire volume of the second zone may have a homogenous index of refraction. Topologies of the optical surfaces bounding the GRIN device may be one or more of planar, spherical, aspherical, and freeform. The optical surfaces or geometrically coupled interfaces may be fully or partially reflective. The optical surfaces or geometrically coupled interfaces may be diffractive or patterned for optical power of color correction. The optical surfaces or geometrically coupled interfaces may be diffractive or patterned for optical multiplexing or optical processing purposes. The optical surfaces or geometrically coupled interfaces may be diffractive or patterned for holographic or optical information processing purposes.

In some implementations, the optical surfaces or geometrically coupled interfaces are diffractive or patterned for polarization processing or polarization-based multiplexing purposes. The first and second zones may be one or more of a film, a sheet, a subcomponent formed of one or more of a polymer, a glass, and a composite material having a varying refractive index or varying Abbe number. The first and second zones may include one or more homogenous layers formed of one or more of a polymer, a glass, and a composite material having a varying refractive index or varying Abbe number. The one or more homogeneous layers may differ from the first and second zones.

A method of forming a gradient index (GRIN) device is also provided, including: forming a first optical zone comprising a first set of geometrically coupled layers; and forming a second optical zone comprising a second set of geometrically coupled layers, wherein a variation of index of refraction in the first zone is different than a variation of index of refraction in the second zone, and wherein surfaces of the geometrically coupled layers have shapes independent of interface topology, such that the surfaces bound a volume of the GRIN device into a lens shape optimized for an optical design.

In some implementations, each layer of the first optical zone has a homogenous index of refraction. Each layer of the second optical zone may have a homogenous index of refraction. The surfaces of the geometrically coupled layers may be planar, spherical, aspherical, or freeform. The surfaces of the geometrically coupled layers may be fully or partially reflective. The first and second optical zones may include one or more of a film, a sheet, a subcomponent formed of one or more of a polymer, a glass, and a composite material having a varying refractive index or varying Abbe number. The first and second optical zones may include one or more homogenous layers formed of one or more of a polymer, a glass, and a composite material having a varying refractive index or varying Abbe number.

A gradient index (GRIN) device is also provided, comprising: a plurality of film layers stacked together to form a GRIN lens, the plurality of film layers comprising a first zone of film layers having a first index of refraction and a second zone of film layers having a second index of refraction different from the first index of refraction, wherein the first and second zones of film layers are physically connected and formed together, wherein at least two film layers in the first zone of film layers are coupled together at a first interface with a first radius of curvature, wherein at least two film layers in the second zone of layers are coupled together at a second interface with a second radius of curvature different than the first radius of curvature.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a diagram of three portions of optical material as known in the art.

FIG. 2A is a diagram of a portion of optical material as known in the art.

FIG. 2B is a diagram of an index of refraction of the portion of optical material in FIG. 2A having a first profile as known in the art.

FIG. 3A is a diagram of a GRIN lens formed from stacked film layers as known in the art.

FIG. 3B is a diagram of an index of refraction of the GRIN lens in FIG. 3A having a second profile as known in the art.

FIG. 4 is a diagram of a GRIN lens formed as nested spheres according to one or more aspects of the present disclosure.

FIG. 5A is a diagram of an exemplary GRIN lens according to one or more aspects of the present disclosure.

FIG. 5B is a diagram of another exemplary GRIN lens according to one or more aspects of the present disclosure.

FIG. 6A is a diagram of an exemplary split GRIN lens according to one or more aspects of the present disclosure.

FIG. 6B is a diagram of aspects of an exemplary split GRIN lens according to one or more aspects of the present disclosure.

FIG. 7 is a diagram an exemplary split GRIN lens and associated optical data according to one or more aspects of the present disclosure.

FIG. 8 is a diagram illustrating manufacturing data for an exemplary split GRIN lens according to one or more aspects of the present disclosure.

FIG. 9 is a diagram illustrating optical performance data for an exemplary split GRIN lens according to one or more aspects of the present disclosure.

FIG. 10A is a diagram illustrating optical performance data for an exemplary split GRIN lens according to one or more aspects of the present disclosure.

FIG. 10B is a diagram illustrating optical performance data for a standard LGRIN lens according to one or more aspects of the present disclosure.

FIG. 11A is a diagram illustrating a correctly modeled ray trace for an exemplary split GRIN lens according to one or more aspects of the present disclosure.

FIG. 11B is a diagram illustrating correctly modeled optical performance data for an exemplary split GRIN lens according to one or more aspects of the present disclosure.

FIG. 12A is a diagram illustrating a ray trace for modeling a GRIN lens with errors.

FIG. 12B is a diagram illustrating optical performance data with errors for a GRIN lens.

FIG. 13A is a diagram illustrating an improved ray trace a GRIN lens.

FIG. 13B is a diagram illustrating improved optical performance data for a GRIN lens.

FIG. 14 is a flowchart showing an exemplary method for forming a split GRIN lens according to one or more aspect of the present disclosure.

### DETAILED DESCRIPTION

The systems, devices, and methods described herein relate to gradient refractive index (GRIN) optics in which individual optical elements are compartmentalized into zones (two or more) that each have independent index of refraction values but are connected through a nested GRIN contour geometry to allow for fabrication of all zones simultaneously, referred to as a “split GRIN lens.”

It is to be understood that the following disclosure provides many different implementations, or examples, for implementing different features of various configurations. Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not in itself dictate a relationship between the various implementations and/or configurations discussed. Moreover, the formation of a first feature over or on a second feature in the description that follows may include implementations in which the first and second features are formed in direct contact, and may also include implementations in which additional features may be formed interposing the first and second features, such that the first and second features may not be in direct contact.

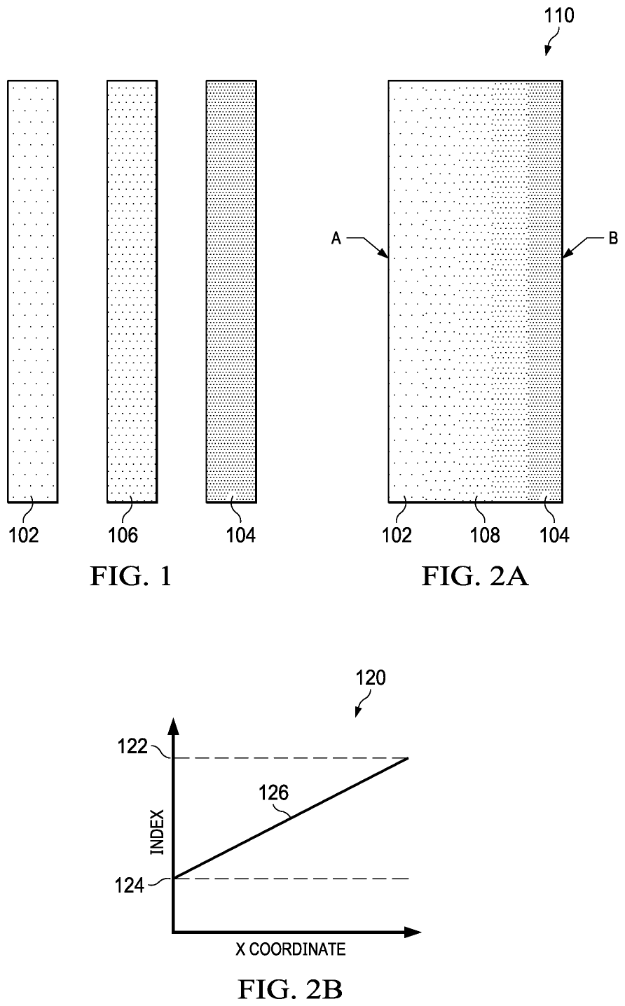

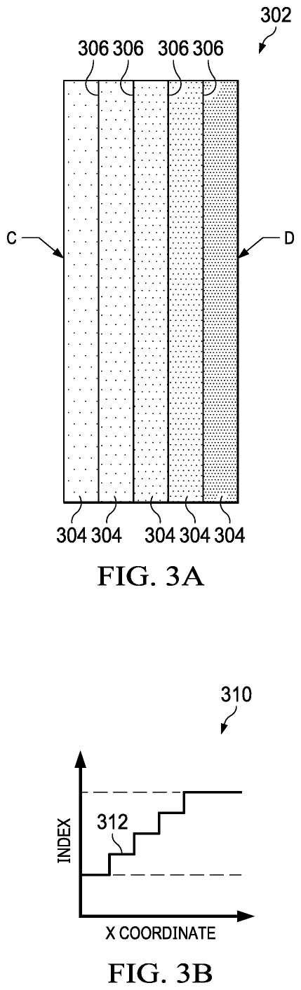

FIG. 1 is a diagram of three portions of optical material that may be used in a conventional GRIN lens as known in the art. GRIN optical elements may include a first optical material 102, a second optical material 104, and a transition 106 including a mixture of the first and second optical materials 102, 104. GRIN optical elements such as lenses may be formed using optical materials in one or more gradient portions such as the gradient portion 110 shown in FIG. 2A. For example, the gradient portion 110 (which may be part of a GRIN lens) may include a first optical material 102 at a first surface A, a second optical material 104 at a second surface B, and a transition 108 between the first optical material 102 and a second optical material 104.

Many conventional GRIN lenses include flat or nearly flat (also referred to as planar) surfaces and may minimize aberrations present in spherical lenses. FIG. 2B shows a graph 120 of the index of refraction along the x-coordinate of the gradient portion 110 of FIG. 2A. The first optical material 102 may have a first value 124 of index of refraction and the second optical material 104 may have a second value 122 of index of refraction (higher than the first index of refraction in this example). The profile 126 of the index of refraction changes gradually over the x-axis of the transition portion 110, changing from the lower value 124 of index of refraction at surface A to the higher value 122 of index of refraction at surface B. In some implementations, the profile 126 in the index of refraction includes a smooth transition including one or more linear, logarithmic, exponential, or other curved shapes.

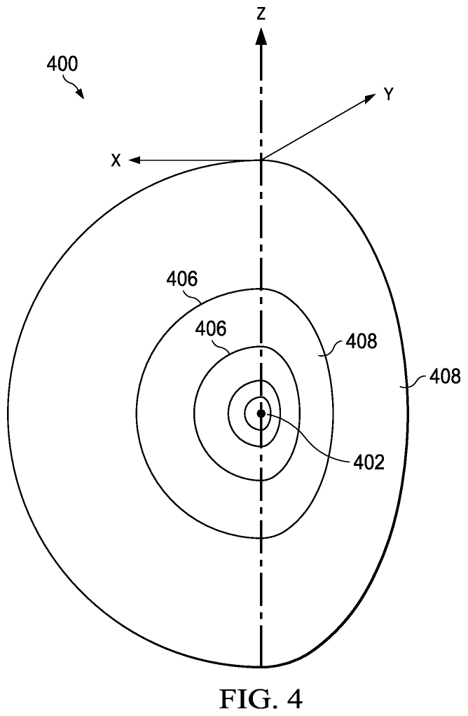

Processing methods for GRIN lenses have typically been aimed at providing a continuously varying index of refraction profile throughout the volume of the lens. However, conventional GRIN lenses are also made with a series of layers each having an individual index of refraction, as shown in FIG. 3A. In this case, GRIN optics may include a layered structure with a smoothly varying relationship between multiple layers and their shapes. For flat films, this can be visualized in FIG. 3A by a GRIN lens 302 formed by stacking film layers 304 together and ensuring that all space is filled between a front surface C and back surface D. In some cases, the refractive index in any one film layer 304 is homogeneous such that the variation in refractive index allowed is the difference between refractive indices associated with each film. This may produce a stepped index of refraction profile 312 as shown in the graph 310 of FIG. 3B.

According to aspects of the present invention, the layers of a GRIN lens may be given nonplanar shapes to achieve increased flexibility of optical design. In particular, the arrangement of film layers in the present invention include “geometrically coupled interfaces,” an important definition with regard to the present invention. The explanation of this term begins by defining “interfaces” and concludes with the definition of a volume of “geometrically coupled interfaces.”

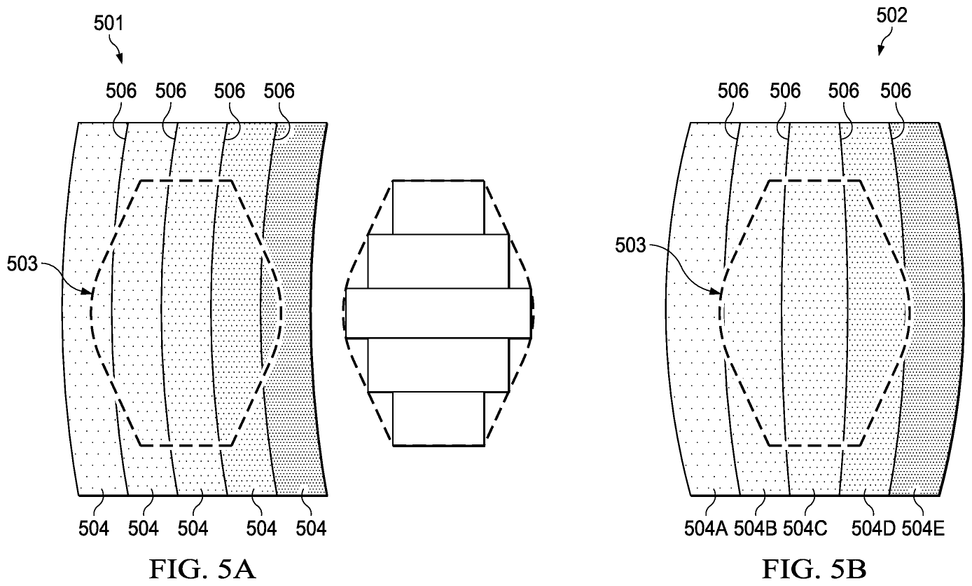

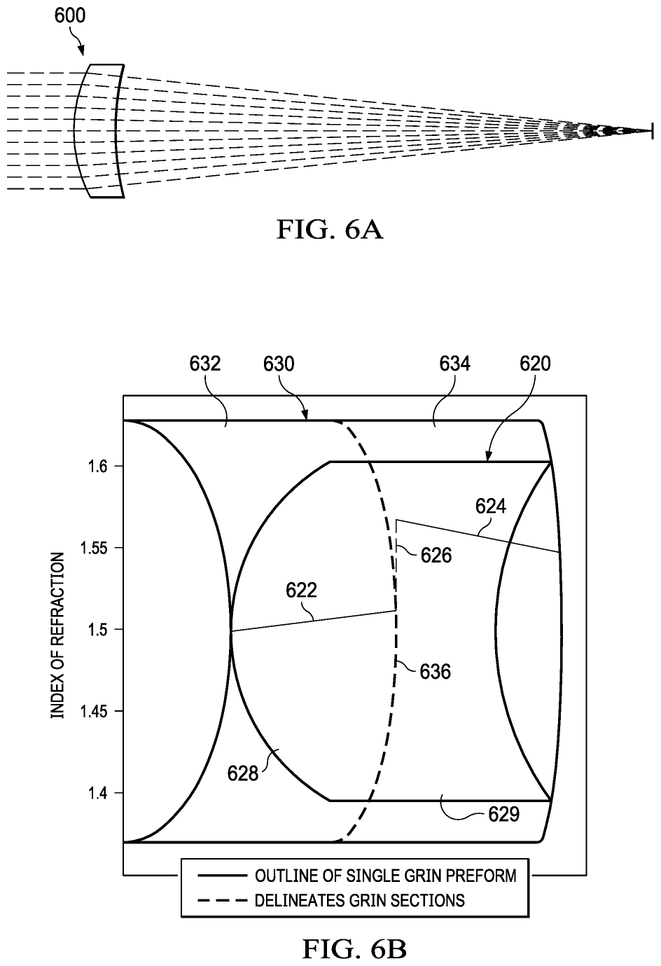

Interfaces can be regarded as the physical boundary between very thin, homogeneous-index films within a lens volume. More accurately, they are the iso-index contour surfaces of an inhomogeneous lens volume, which holds whether or not the “layers” have finite thicknesses or represent the infinitesimal iso-index contours of a continuous index distribution. A fused stack of thin, flat films would have a series of planar interfaces (such as interfaces 306 in FIG. 3A). A GRIN volume may be represented by curved shapes such as the onion-shaped cross-sectional volume 400 of FIG. 4. This volume 400 may include a series of (nearly) spherical interfaces 406. These interfaces 406, pertaining to material within the lens volume, are distinct and entirely independent of lens surfaces of a lens that may be formed from the volume 400, as further shown in FIGS. 5A and 5B. If one cuts a bi-convex lens out of a blank of fused, flat films, the interfaces would still be planar even though the lens has spherical surfaces.

Geometrically coupled interfaces are a set of contiguous interfaces whose shape varies slowly (or not at all) from interface to interface, and completely fills the volume between the first and last interface, subject to possible differences between the area of the front and back interface. Considering again the onion-shaped cross-sectional volume 400, the first interface 402 is (extrapolated to a mathematical ideal) a single point at the original center of the cross-sectional volume 400. Each shell of increasing radius is an interface 406 (with internal volume 408), continually gaining a greater area out to the final size of the shape, so that all space is filled in the final hemisphere.

Given that real onions are not perfect spheres, they also represent an excellent example of what the inventors mean by a volume of geometrically coupled interfaces. An equation for the shape of every (real) onion interface might be complicated to describe, but it is clear that each interface is “geometrically coupled” to its neighbor in such a way that they do not cross each other and they add successively in a manner that continuously fills space between the first interface and the last interface, even if the first and last interfaces are quite different from one another. If one were able to construct an onion at will, one can easily imagine replacing groups of adjacent layers, separated by the interfaces of the original onion, with non-onion material. The volume and the interfaces of the new element would be identical to that of the original onion, but the composition would abruptly change from onion to non-onion at the interfaces which bound the volume that was replaced.

A further example of “geometrically coupled interfaces” is shown in FIGS. 5A and 5B. In particular, stacked films layers 504 in lens volumes 501, 502 may be distorted by being bent slightly around a curved surface, as shown in FIGS. 5A and 5B. In this case, the geometrically coupled interfaces 506 between film layers 504 are no longer planar, but there will still be a clear relationship from film layer 504 to film layer 504. In the implementation of FIG. 5A, the topology of the interfaces 506 between stacked film layers 504 may be similar, although in some cases the topology may change shape across the volume of the lens. For example, in the implementation of FIG. 5B, the topology of each film layer 504 is related to that of adjacent film layers 504. For example, the shape of the first film layer 504A is closely related to the shape of the second film layer 504B. The shape of the second film layer 504B is closely related to the shape of the third film layer 504C, and so on for the fourth film layer 504D, fifth film layer 504E, and up to the nth film layer. The shape of the nth film layer may not look much like the shape of the first film layer 504A, but the transition to that shape via all the intermediate film layers will have been smoothly varying. The thicknesses of film layers 504 may be thinned or bunched up across the lens structure 502, but at every point within the volume no film layer 504 is terminated or goes to zero thickness.

A lens may be cut out of the volumes 501, 502, for example in the lens shape 503 as shown by the dotted line (representing exterior surfaces of the lens) superimposed over the volumes 501, 502. As shown by the comparison of FIGS. 5A and 5B, cutting the same lens shape 503 from different volumes 501, 502 results in lenses with different optical characteristics. In particular, the interfaces 506 within the lenses 503 may vary depending on the lens and can have horizontal or vertical orientations, as well as other orientations. This also illustrates that the topography of lens surfaces shown by the curves of the lens shape 503 may be fabricated with topologies independent of the internal geometry of the interfaces 506 within the lens volume 501, 502, and may be planar, spherical, aspheric, or freeform in nature, as well as having other shapes. Geometrically coupled interfaces suitable for this design method may be formed via sequential vapor deposition techniques, additive manufacturing techniques, seed/diffusion techniques, and other means. In some implementations, the split GRIN element and its surfaces may be manufactured directly, without a separate “cutting, polishing, or otherwise defining a lens shape” step.

The interfaces 506 between film layers 504 may have various optical properties. For example, these interfaces 506 may be fully or partially reflective. The interfaces 506 may be diffractive or patterned for added optical power or color correction, optical multiplexing or optical processing purposes, holographic or optical information processing purposes, or polarization processing or polarization-based multiplexing purposes.

As discussed above, the GRIN lenses discussed herein may include one or more homogenous zones, which may be constructed from polymer, glass, blend, or composite structures with refractive index or Abbe numbered materials. In some implementations, these homogenous zones differ from the GRIN subcomponent materials.

A further step in designing novel GRIN lenses is to consider the individual film thicknesses that make up the geometric model of the GRIN structure as being very, very thin. This allows treatment of the relationship between the shape of film interfaces and their position in space as a continuous, analytic function. Physical film thicknesses (such as the thicknesses of film layers 504) may be thicker, meaning that an optic would sample this continuous function at discrete points, but the relationship between each film layer interface can still be described by a continuous model. This also illustrates the description of GRIN zones manufactured via diffusion processes, for example, with a starting point of fused initial blanks of material that are allowed to undergo diffusion. The final GRIN optic consists of continuous iso-index contour shapes that can be described as a set of geometrically coupled interfaces.

Defining a single homogenous index of refraction for each film layer 504 allows a description of the shape of iso-index contours within a volume of material, and how they are nested in space according to a continuous function that is able to be accurately modeled. The geometric relationship among the layer shapes is independent of the refractive index values chosen for any of the film layers 504. For example, with reference to FIGS. 5A and 5B, the distribution of the refractive index in the volume between geometrically coupled interfaces 506 is independent of the shape of the interfaces 506. Even in a situation where the interfaces 506 are continuous (such as a diffusion process), the shape of the interfaces 506 is distinct from the refractive index at each one.

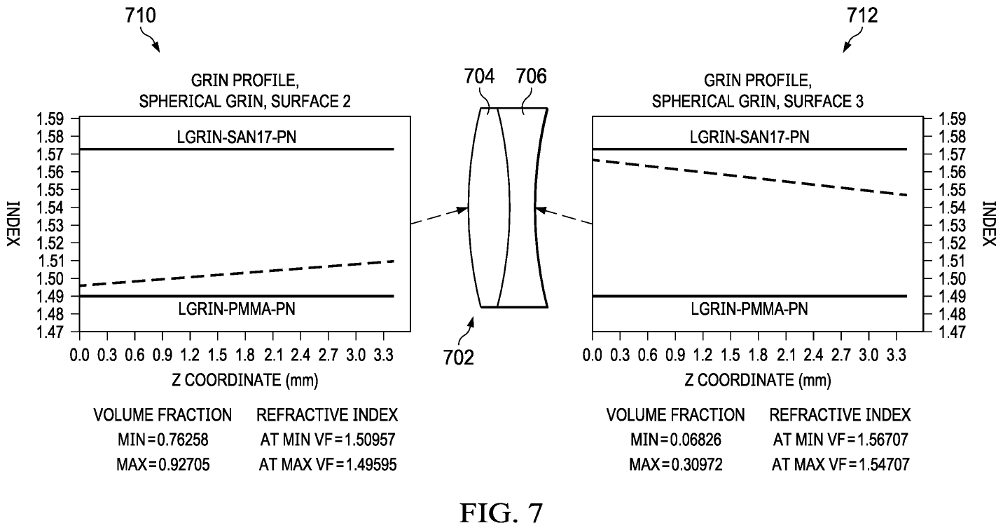

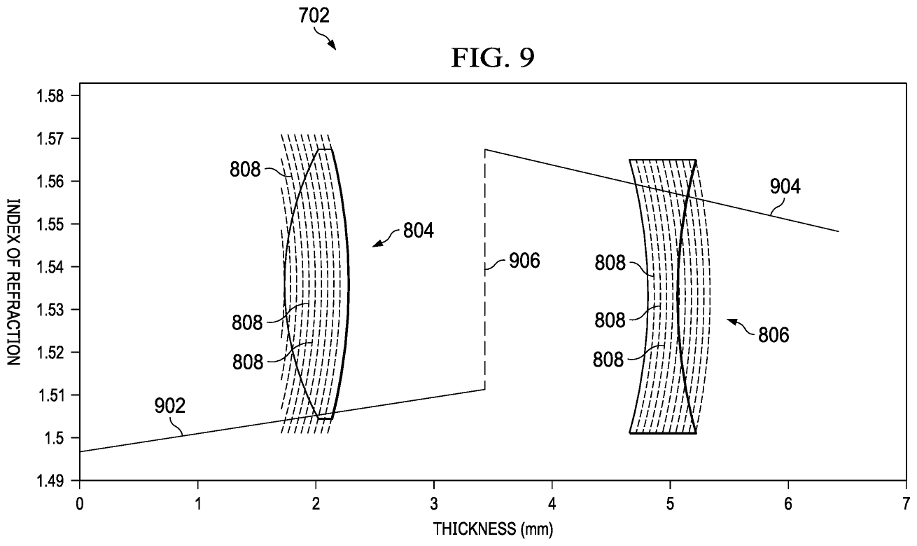

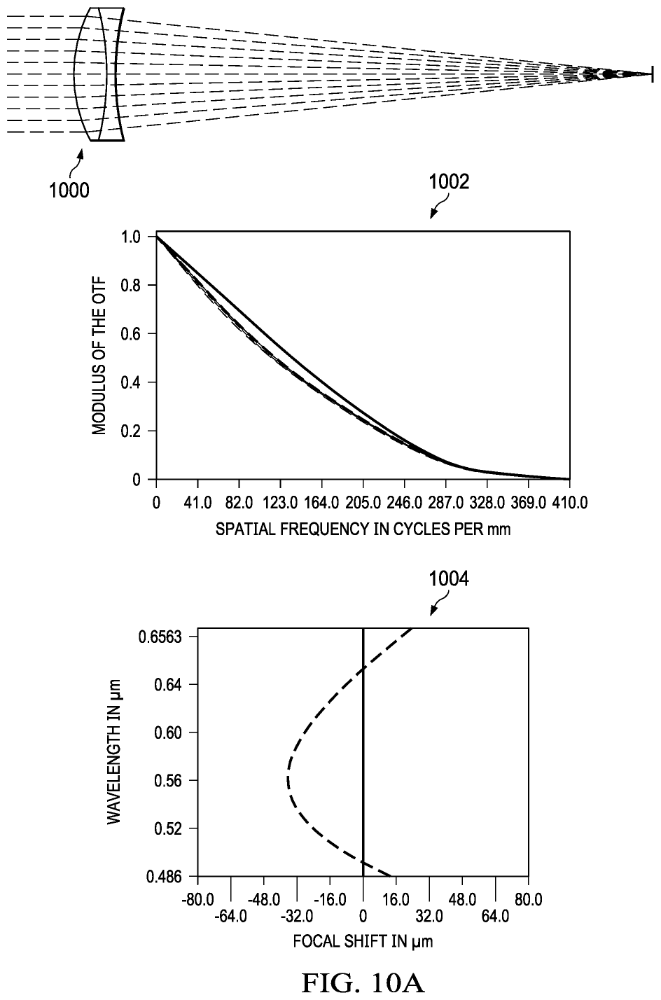

With reference to FIG. 6A, an example of a split GRIN lens 600 (applying the principles discussed in reference to FIGS. 4, 5A, and 5B) is shown. This split GRIN lens 600 has a meniscus shape with high power and aberration correction. A further view of a split GRIN lens 620 is shown in FIG. 6B. In this example, the split GRIN lens 620 is formed from a GRIN preform 630 which includes a first zone 632 and a second zone 634 each with different smoothly varying indices of refraction joined at an interface 636. The GRIN preform 630 may be formed in a single process that involves stacking many optical layers together, as shown in more detail with reference to FIGS. 8 and 9. After shaping the outer edges of the split GRIN lens 620, the resulting split GRIN lens 650 may have some optical performance features similar to a doublet lens with a first double-convex lens portion or zone 628 and a second double-concave lens portion or zone 629. The first lens zone 628 has a first smoothly varying index of refraction 622 and the second lens zone 629 has a second smoothly varying index of refraction 624 with a discontinuity 626 at the interface 636 between lens zones 628, 629. This layout may allow the split GRIN lens 620 to strongly focus light and correct for aberrations. In other implementations, split GRIN lenses may be made to simulate other lens shapes, including various combinations of single convex, single concave, meniscus, double convex, and double concave lens elements. The split GRIN lens 620 provides a single optical element proving high optical power and the aberration control of curved ray paths. The split GRIN lens 620 also leverages two or more zones 632, 634 of continuously varying gradient index material that also include step-changes in the refractive index in way that that can be modeled and fabricated for use, as shown in more detail with reference to FIGS. 8 and 9.

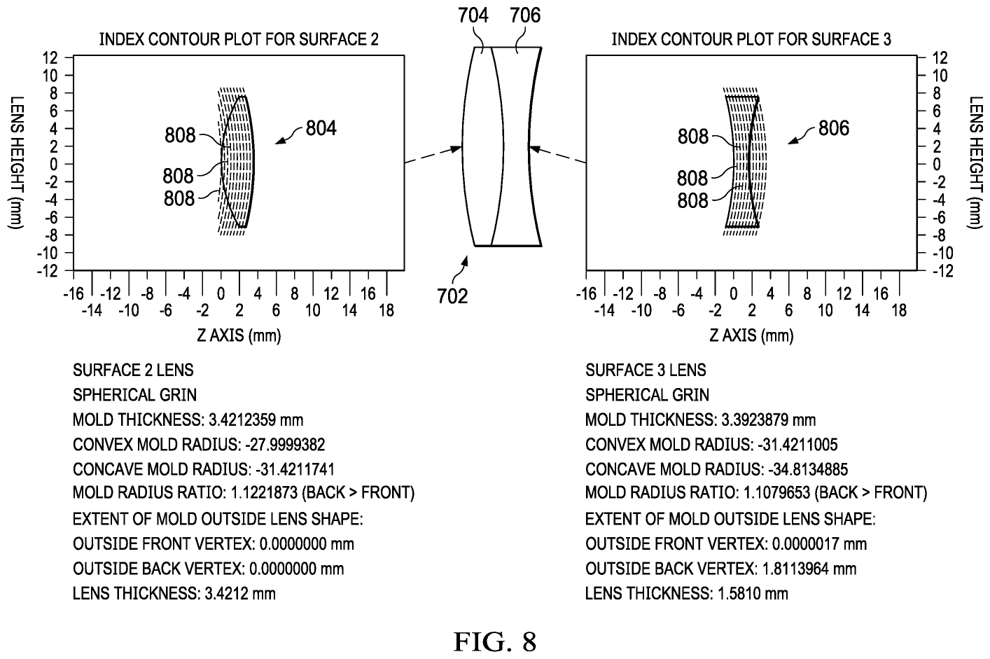

Further optical data for the split GRIN lens 702 is shown in FIG. 7. The index of refraction of the double convex lens zone 704 varies from 1.49595 to 1.50957 as shown in the first graph 710 and the index of refraction of the double concave lens zone 706 varies from 1.56707 to 1.54707 as shown in the second graph 712. The split GRIN lens may be modeled around other lens assemblies, including one or more lens elements with various shapes and optical properties.

FIGS. 8 and 9 show details of the stacked film layers of the split GRIN lens 702. In particular, the stacked film layers 808 are shown with reference to a first lens zone 804 and a second lens zone 806 with a homogenous index of refraction. While the split GRIN lens 702 appears as two different elements 804, 806 (which may also be referred to as “zones,” each containing a subset of the stacked film layers 808 in the split GRIN lens), the split GRIN lens 702 may be made with a single stacking recipe in a single molding process (in which the zones 804, 806 are formed next to each other). The individual film layers 808 are shown stacked together in FIGS. 8 and 9, and may have curved geometrically connected interfaces where the various film layers 808 meet. As discussed with reference to FIGS. 4, 5A, and 5B, the shape of the film layers 808 may change gradually across the volume of the split GRIN lens, for example having a convex mold radius of about −28 mm in the first zone 804 and a concave mold radius of about −34 mm in the second zone 806.

In some implementations, hundreds or thousands of layers 808 are stacked together to form the split GRIN lens 702. In particular, the layers 808 may be stacked together to form sheets, which may be shaped and formed into larger zones 804, 806. The layers 808 may be formed from various polymers and other materials with varying indices of refraction. In some implementations, each layer 808 includes a single homogenous index of refraction. Layers 808 with slightly different indices of refraction may be stacked together to form smoothly varying indices of refraction of larger stacks or zones 804, 806.

FIG. 9 shows a closeup view of the zones 804, 806 of the split GRIN lens 702. As discussed above, the first zone 804 may be made up of stacked optical layers 808 each having a homogenous index of refraction. Together, these stacked film layers 808 produce a smoothly varying index of refraction 902 for the first zone 804 and a different smoothly varying index of refraction 904 for the second zone 806 with a discontinuity 906 in the index of refraction between the zones 804, 806. This particular arrangement of film layers may be used to simulate the optical performance of a doublet lens, with similar differences in index of refraction between the various lens elements, as well as a discontinuity at the interface between the lenses.

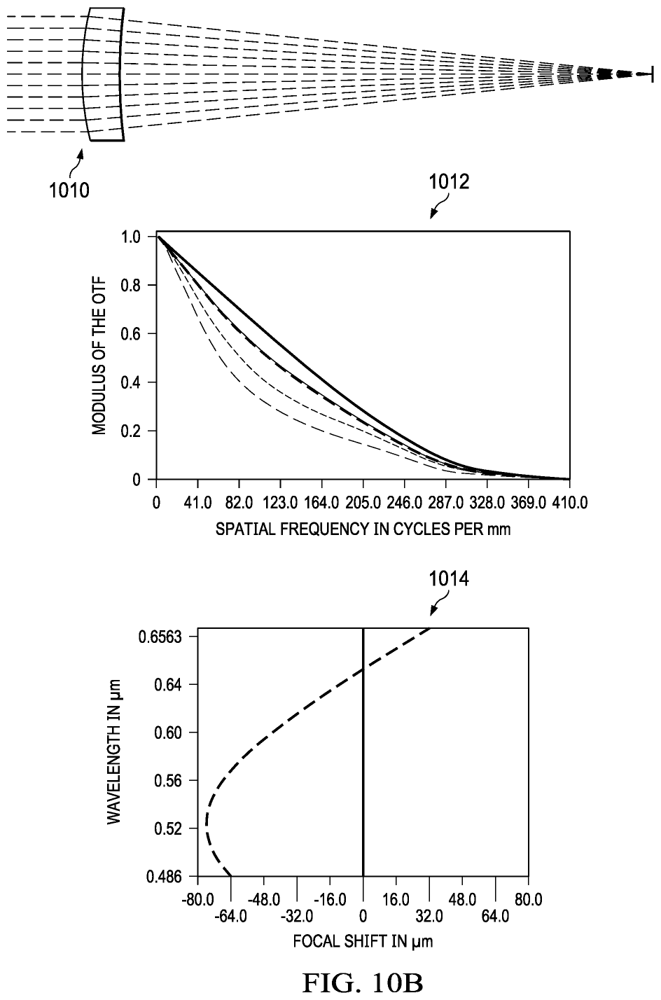

A comparison of a split GRIN lens 1000 and a standard nanolayer GRIN (LGRIN) lens 1010 having the same mold properties and associated shape is shown in FIGS. 10A and 10B. This comparison illustrates the improved image quality achieved by the split GRIN lens when comparing the modulus of the optical transfer function (OTF) graphs 1002, 1012, and in particular, the elimination of spherical aberrations by the split GRIN lens 1000. Furthermore, the comparison of the focal shift graphs 1004, 1014 graphs of the two different lenses shows the superior optical performance of the split GRIN lens 1000 regarding focal shift.

Further improvements associated with split GRIN lenses 1000 include greatly increasing the degrees of freedom of optical design with GRIN materials because the present invention provides for decoupling of the front surface and rear surface index profiles (which can also be thought of as decoupling the volume index profile from the surface index profiles). This allows much more control in the design process and allows for types of aberration (monochromatic and color) that is not possible with other optical elements. Furthermore, split GRIN lenses 1000 may include improved adjustability that allows refinement of performance instead of reliance on the GRIN lens to “create” performance. For example, split GRIN lenses 1000 leverage the mean index contrast between the two virtual lens elements, allowing split GRIN lenses 1000 to be used to apply higher order corrections.

Split GRIN lenses 1000 may also provide for reduced manufacturing tolerances in fabricating GRIN optical elements. This is because of transitioning the first order correction to the mean index of refraction of each zone within the split GRIN lens 1000, so the tolerances become similar to that of traditional homogenous optics. This allows for the GRIN profile to focus on higher-order corrections and typically results into more gradual and less complex (e.g., linear as opposed to quadratic) index profiles as well as larger radius of curvature GRIN contours. In particular, split GRIN lenses 1000 may be able to achieve high optical performance with gentler molding conditions than other GRIN lenses (in some cases up to two to three times gentler) and requiring a smaller range of material composition to manufacture the split GRIN lens 1000. Another advantage of the split GRIN lens 1000 is that the design may be chose to include only linear GRIN profiles which have been shown to be more fault tolerant than profiles with higher order shapes.

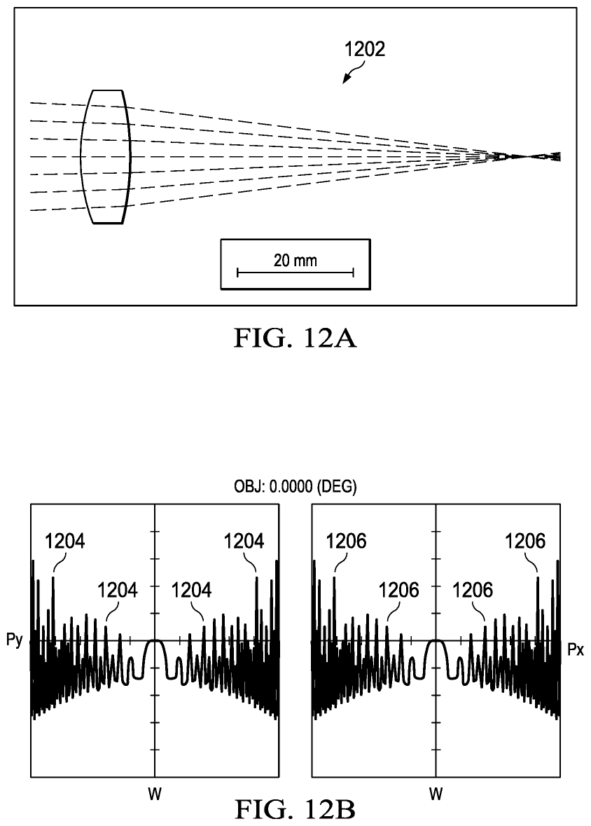

The novelty of the split GRIN lens disclosed herein is further exemplified by the shortcomings of existing GRIN lens design to model sharp discontinuities in index of refraction. Traditionally, raytracing GRIN optical paths across these discontinuities results in large numerical errors, as shown in FIGS. 12A and 12B. Without a priori knowledge of where a discontinuity lies inside a bulk GRIN material, numerical stepping routines with finite step sizes cannot land exactly on the interface to determine the proper ray path. By ‘splitting’ the GRIN into different zones, each of which are separately well-behaved, numerical ray trace engines can know exactly where to terminate and start rays across each interface. The fabrication process proceeds with overall element as a single ‘entity’, but the numerical ray trace engine can treat elements between interfaces as separate.

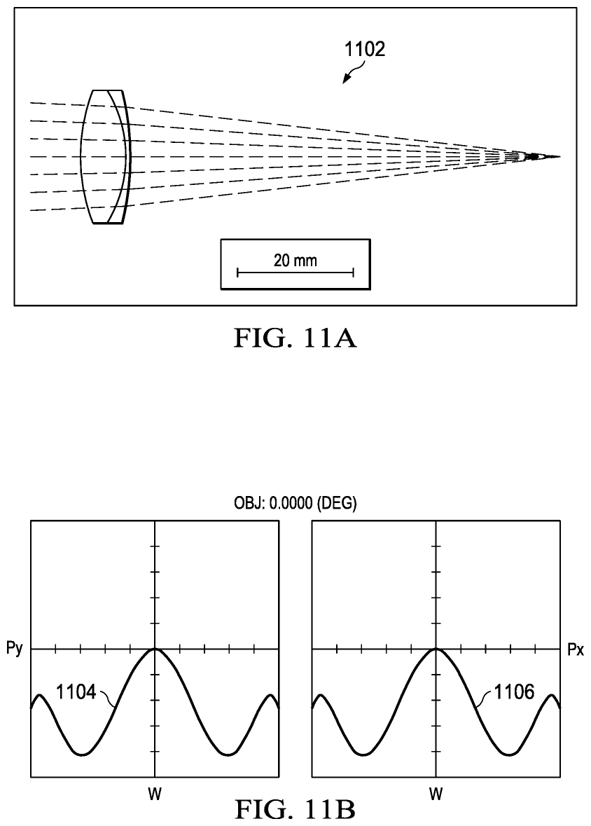

FIGS. 11A and 11B show a correctly modeled doublet lens modeled with discrete, homogeneous lens elements. Numerical raytracing 1102 finds the proper intersection points at the internal interface so that transmitted rays are accurate as shown in FIG. 11A. Optical Path Difference (OPD) graphs in FIG. 11B, which illustrate values used to compute wavefront properties (optical quality) of a focused beam, are smoothly varying (shown by the smooth curves of lines 1104, 1106).

Some of the difficulties of modeling GRIN optics with internal discrete index discontinuities, such as split GRIN lenses, include errors as shown in FIGS. 12A and 12B. FIG. 12A shows a ray trace diagram 1202 through the same lens as FIG. 11A, but here modeled as a traditionally described GRIN lens, which is forced to incorporate an internal step change in the index of refraction along the internal, curved interface. FIG. 12A shows that rays no longer focus correctly with typical analysis settings. Furthermore, the OPD graphs display obvious numerical artifacts 1204, 1206 (as compared to the smooth lines 1104, 1106 in FIG. 11B), due to rays not locating the internal interface correctly.

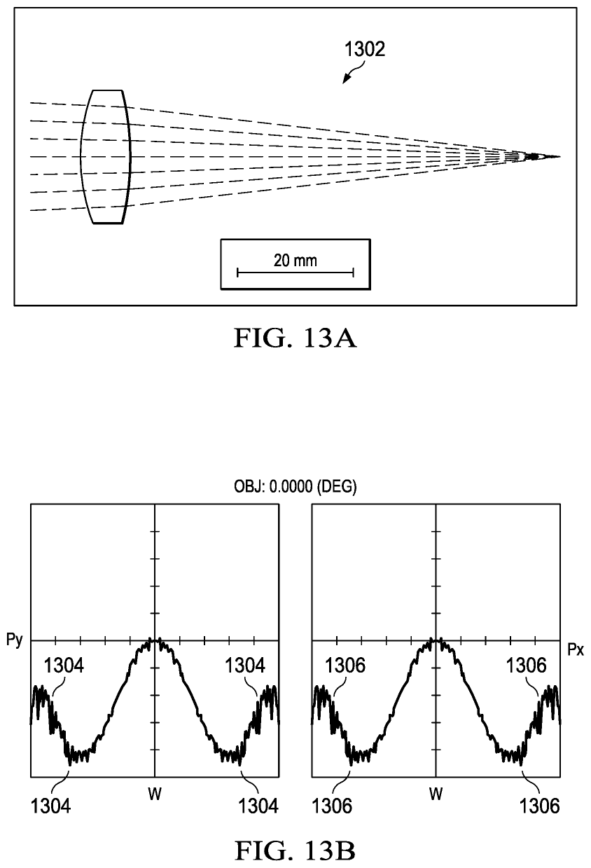

One way to reduce the size of these errors is to use smaller numerical step sizes, albeit this approach includes a penalty of orders of magnitude in numerical execution time. To illustrate the size of this penalty, FIGS. 13A and 13B show a ray trace diagram 1302 of the same lens as FIG. 12, modeled with a step size 200 times smaller than usual, which requires 200× the numerical evaluations. The rays are clearly less aberrated in the ray trace diagram 1302 of FIG. 13A as compared to the ray trace diagram 1202 of FIG. 12A. The correct shape of the OPD function is starting to appear in the graphs of FIG. 13B, but numerous artifacts 1304, 1306 still exist, some still having about 20% of the total amplitude. These errors are still too large for accurate wavefront metrics such as calculations of the modulation transfer function, a common lens quality metric. The step size would need to be reduced even more for such an analysis. Analyzing a single lens this way is certainly possible, given enough time. Incorporating this additional level of effort into an optimization loop for optical design, however, multiplied by its overall millions of iterations, presents a significant challenge for existing GRIN modeling methods. As discussed above, the difficulty of even correctly modeling a GRIN lens with internal discontinuities shows the novelty of the split GRIN lens design.

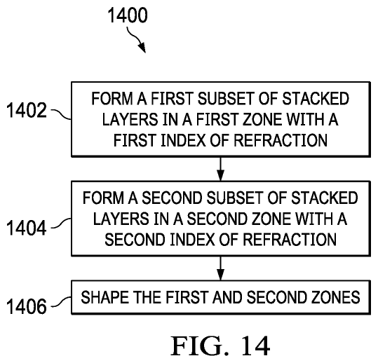

FIG. 14 illustrates an exemplary method for forming a split GRIN optical device as shown in FIGS. 6A-9. In some implementations, the split GRIN lens may be made to simulate the optical performance of a doublet lens with shaped stacked film layers.

The method 1400 may begin at step 1402 to form a first subset of stacked layers in a first zone with a first index of refraction. As discussed above, these layers (such as layers 808 shown in FIGS. 8 and 9) may be stacked together such that their surfaces meet at nonplanar interfaces. In some implementation, these interfaces are curved with a particular radius of curvature. In other implementations, these interfaces have an aspheric or complex shape. The shape of the interfaces may vary across the volume of the split GRIN lens, and in some cases, may vary incrementally. Each stacked layer may have a homogenous index of refraction. The stacked layers may comprise any type of optical material including glass, plastics, composites, or other materials.

The method 1400 may include step 1404 to form a second subset of stacked layers in a second zone with a second index of refraction. As discussed above, steps 1402 and 1404 may be carried out in a single manufacturing step to form all of the stacked layers, such that the first and second zones are formed together and adjacent to each other. In some implementations, the index of refraction of the second zone is different than the first zone with a discontinuity at the interface between the zones to achieve similar optical performance to a doublet lens.

The method 1400 may include step 1406 to shape the first and second zones. This step may include removing material from the first and second zones, in some cases by cutting or polishing the lens. In some implementations, such as the split GRIN lens shown in FIGS. 6A-9, the split GRIN lens has a meniscus shape. In other implementations, split GRIN lenses may have a different meniscus shape, a bioconcave shape, a bio convex shape, or another complex lens shape. In some implementations, the split GRIN element and its surfaces might be manufactured directly, without a separate “cutting, polishing, or otherwise defining a lens shape” step.

The foregoing outlines features of several implementations so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the implementations introduced herein. One of ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. § 1.72(b) to allow the reader to quickly ascertain the nature of the technical disclosure. It is submitted with the understanding that it will not be used to interpret or limit the scope or meaning of the claims.

Moreover, it is the express intention of the applicant not to invoke 35 U.S.C. § 112(f) for any limitations of any of the claims herein, except for those in which the claim expressly uses the word “means” together with an associated function.

What is claimed is:

1. A gradient index (GRIN) device, comprising:
a lens volume having a plurality of geometrically coupled interfaces;
a first zone including a first contiguous subset of the plurality of geometrically coupled interfaces; and
a second zone including a second contiguous subset of the plurality of geometrically coupled interfaces, immediately adjacent to the first zone such that the first zone and the second zone meet at a zone interface,
wherein an index of refraction within the first zone varies smoothly across the first contiguous subset,
wherein an index of refraction within the second zone varies smoothly across the second contiguous subset,
wherein an index of refraction or its spatial gradient at the zone interface exhibits a step change, and
wherein optical surfaces bounding the GRIN device have shapes independent of the interface topology of the GRIN device such that the optical surfaces bound the lens volume into a lens shape optimized for an optical design.

2. The GRIN device of claim 1, wherein an entire volume of the first zone has a homogenous index of refraction.

3. The GRIN device of claim 1, wherein an entire volume of the second zone has a homogenous index of refraction.

4. The GRIN device of claim 1, wherein topologies of the optical surfaces bounding the GRIN device are one or more of planar, spherical, aspherical, and freeform.

5. The GRIN device of claim 1, wherein the optical surfaces or geometrically coupled interfaces are fully or partially reflective.

6. The GRIN device of claim 1, wherein the optical surfaces or geometrically coupled interfaces are diffractive or patterned for optical power of color correction.

7. The GRIN device of claim 1, wherein the optical surfaces or geometrically coupled interfaces are diffractive or patterned for optical multiplexing or optical processing purposes.

8. The GRIN device of claim 1, wherein the optical surfaces or geometrically coupled interfaces are diffractive or patterned for holographic or optical information processing purposes.

9. The GRIN device of claim 1, wherein the optical surfaces or geometrically coupled interfaces are diffractive or patterned for polarization processing or polarization-based multiplexing purposes.

10. The GRIN device of claim 1, wherein the first and second zones comprise one or more of a film, a sheet, a subcomponent formed of one or more of a polymer, a glass, and a composite material having a varying refractive index or varying Abbe number.

11. The GRIN device of claim 1, wherein the first and second zones comprise one or more homogenous layers formed of one or more of a polymer, a glass, and a composite material having a varying refractive index or varying Abbe number.

12. The GRIN device of claim 11, wherein the one or more homogeneous layers differ from the first and second zones.

13. A method of forming a gradient index (GRIN) device, comprising:
forming a first optical zone comprising a first set of geometrically coupled layers; and
forming a second optical zone comprising a second set of geometrically coupled layers,
wherein a variation of index of refraction in the first zone is different than a variation of index of refraction in the second zone, and
wherein surfaces of the geometrically coupled layers have shapes independent of interface topology, such that the surfaces bound a volume of the GRIN device into a lens shape optimized for an optical design.

14. The method of claim 13, wherein each layer of the first optical zone has a homogenous index of refraction.

15. The method of claim 13, wherein each layer of the second optical zone has a homogenous index of refraction.

16. The method of claim 13, wherein the surfaces of the geometrically coupled layers are planar, spherical, aspherical, or freeform.

17. The method of claim 13, wherein the surfaces of the geometrically coupled layers are fully or partially reflective.

18. The method of claim 13, wherein the first and second optical zones comprise one or more of a film, a sheet, a subcomponent formed of one or more of a polymer, a glass, and a composite material having a varying refractive index or varying Abbe number.

19. The method of claim 13, wherein the first and second optical zones comprise one or more homogenous layers formed of one or more of a polymer, a glass, and a composite material having a varying refractive index or varying Abbe number.

20. A gradient index (GRIN) device, comprising:
a plurality of film layers stacked together to form a GRIN lens, the plurality of film layers comprising a first zone of film layers having a first index of refraction and a second zone of film layers having a second index of refraction different from the first index of refraction, wherein the first and second zones of film layers are physically connected and formed together,
wherein at least two film layers in the first zone of film layers are coupled together at a first interface with a first radius of curvature, wherein at least two film layers in the second zone of layers are coupled together at a second interface with a second radius of curvature different than the first radius of curvature.
